(19) United States
(12) Patent Application Publication
(10) Pub. No.: US 2024/0278496 A1
(43) Pub. Date: Aug. 22, 2024

(54) ADDITIVE MANUFACTURING METHOD AND APPARATUS FOR ABRASIVE ARTICLES

(71) Applicant: Admatec Europe B.V., Alkmaar (NL)

(72) Inventor: Jacob Jan Saurwalt, Alkmaar (NL)

(73) Assignee: Admatec Europe B.V., Alkmaar (NL)

(21) Appl. No.: 18/570,671

(22) PCT Filed: Jul. 5, 2022
(86) PCT No.: PCT/EP2022/068616

§ 371 Date: Dec. 15, 2023

(30) Foreign Application Priority Data
Jul. 5, 2021 (EP) 21183635.8

(51) Int. Cl. B29C 64/268; B24D 18/00; B29C 64/106; B29C 64/245; B29C 64/30; B29K 105/00; B29K 105/16; B33Y 10/00; B33Y 30/00; B33Y 40/00

(52) U.S. Cl. CPC B29C 64/268; B24D 18/009; B29C 64/106; B29C 64/245; B29C 64/30; B33Y 10/00; B33Y 30/00; B33Y 40/00; B29K 2105/0058; B29K 2105/16

(57) ABSTRACT

A method of additive manufacturing for manufacturing an abrasive article (1) layer-by-layer. The method comprises depositing a layer of slurry (4), wherein the slurry (4) comprises a mixture comprising a liquid and abrasive particles, and applying a radiation source (6) on the layer of slurry (4) for curing thereof before depositing a new layer of slurry (4), wherein the radiation source (6) comprises a rotating exposure. In a further aspect, an additive manufacturing apparatus for manufacturing an abrasive article (1) layer-by-layer is also provided.

### FIELD OF THE INVENTION

The present invention relates to a method of additive manufacturing for manufacturing an abrasive article layer-by-layer, and, in a further aspect, to an additive manufacturing apparatus for manufacturing an abrasive article layer-by-layer.

### BACKGROUND ART

US patent publication US2018/104793 discloses a method of making a vitreous bond abrasive article. In an embodiment, the method comprises steps of depositing a layer of loose powder particles in a confined region, jetting a liquid binder precursor material in predetermined regions of the layer of loose powder particles, and converting the liquid binder precursor material into a temporary binder material that bonds together particles of the loose powder particles in the predetermined regions to form a layer of bonded powder particles. These steps are carried out a plurality of times to generate an abrasive article preform, which is then heated to provide the vitreous bond abrasive article.

International patent publication WO2006/091519 discloses a system method for manufacturing abrasive articles. In an embodiment, a container includes a mixture of abrasive particles and powder binder, wherein a platform is lowered to permit formation of abrasive article layer-by-layer. Once the platform has been lowered by fractions of an inch, a roller deposits build material over the abrasive article and the material within the container. An energy source directs patterned energy on the surface of the material to form a subsequent layer of abrasive article.

### SUMMARY OF THE INVENTION

The present invention seeks to provide an improved additive manufacturing method for manufacturing an abrasive article in a layer-by-layer fashion.

According to the present invention, a method according to the preamble defined above is provided, wherein the method comprises depositing a layer of slurry, wherein the slurry comprises a mixture comprising a liquid and abrasive particles, and applying a radiation source on the layer of slurry for curing thereof before depositing a new layer of slurry, and wherein the radiation source comprises a rotating exposure.

This may provide an abrasive article of manufacture with a high accurate form and high symmetry, utilising the additive manufacturing process to manufacture the abrasive material for the abrasive article in a reliable layer-by-layer fashion, wherein the starting material is a slurry instead of e.g. powder.

### SHORT DESCRIPTION OF DRAWINGS

The present invention will be discussed in more detail below, with reference to the attached drawings, in which

FIG. 1 shows a schematic view of a method for manufacturing an abrasive article layer-by-layer, according to an embodiment of the present invention;

FIGS. 2A-D each show a top view of a method for manufacturing an abrasive article layer-by-layer, according to four further embodiments of the present invention;

FIG. 3 shows a perspective of the cured layers of slurry, according to an embodiment of the present invention;

FIG. 4 shows a perspective view of an abrasive tool comprising the abrasive material, according to an exemplary embodiment of the present invention;

FIG. 5 shows a perspective view of an abrasive tool comprising the abrasive material, according to a further exemplary embodiment of the present invention;

FIG. 6 shows a schematic view of an additive manufacturing apparatus for manufacturing an abrasive article layer-by-layer, according an embodiment of the present invention,

FIG. 7 shows a schematic top view of a stack of cured layers created by a method for manufacturing an abrasive article layer-by-layer, according to an embodiment of the present invention, and

FIG. 8 shows a schematic view of a source to generate a spot of an exposure beam used in a method for manufacturing an abrasive article layer-by-layer, according to an embodiment of the present invention.

### DESCRIPTION OF EMBODIMENTS

In general, abrasive material on e.g. a grinding wheel consists of bonded grains. In various grinding and abrasive machining operations, the rotation of the grinding should be robust and of good accuracy to avoid irregular cutting behaviour and chatter. Furthermore, an accurate form (i.e. shape) of the grinding wheel is also desired to obtain a good, final profile in the workpiece. Shaping the accurate form of the grinding wheel is a process more commonly known as profiling or dressing. For most grinding processes, the accuracy of the form (and run out) of the grinding wheel should be on the order of μm.

However, the accurate profiling or dressing of the grinding wheel still proves to be difficult due to the wear resistance of the grinding wheel. Due to this difficultly, the production of high abrasive grinding wheels is relatively time-consuming and expensive.

As a result, there is a need to overcome this drawback, and provide a technique to manufacture grinding wheels and similar abrasive articles with a high accurate form, yet, in a simple and less time-consuming manner.

Moreover, since the starting product for most manufacturing processes is usually a powder of (abrasive) particles, it would be desirable to make use of other starting products to provide more flexibility in the manufacturing process.

The present invention embodiments provide an method of additive manufacturing for manufacturing an abrasive article in a layer-by-layer fashion, utilising the additive manufacturing process to profile or dress an abrasive article with a high accurate form, yet, ease production and reduce associated delivery times and costs.

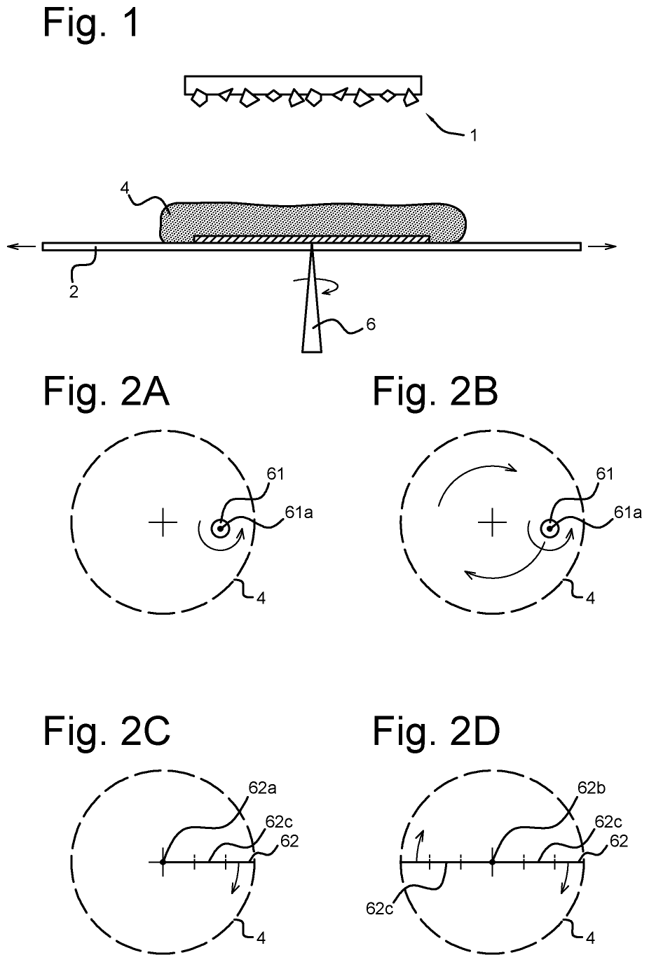

FIG. 1 shows a schematic view of a method of additive manufacturing for manufacturing an abrasive article 1 layer-by-layer, according to an embodiment of the present invention. In the embodiment shown, the method comprises depositing a layer of slurry 4, wherein the slurry 4 comprises a mixture comprising a liquid and abrasive particles. The layer of slurry 4 may be deposited on e.g. a platform or a substrate 2. The mixture comprising the liquid and abrasive particles eventually forms the (printed) abrasive material for the abrasive article 1.

Instead of using e.g. a powder, the slurry 4 is the starting product for manufacturing an abrasive material 1 layer-by-layer, and it may be implemented as a paste, resin, dispersion, suspension etc., depending on the liquid in the mixture. As a non-limiting example, the slurry 4 may comprise a resin comprising a light-polymerisable material, e.g. polymers with abrasive particles.

As an exemplary range, the mixture may have between 10 and 70% volume of particle content (in general), which would allow a very homogenous layer of slurry 4 to be processed, as well as a stable dispersion of the particles in the mixture. It is pointed out that, in addition to abrasive particles, the general particle content may comprise other particles e.g. supporting grains or fillers.

The range of abrasive particle content in the mixture may vary depending on the abrasive article 1 being manufactured. For an abrasive article 1 comprising solely of abrasive particles, the mixture may have between e.g. 12.5 and 50% volume of abrasive particle content, or even less than 10% of abrasive particle content for an abrasive article 1 with a primary grinding or polishing grain.

The diameter of the abrasive particles (in mixture) may also vary depending on the abrasive article 1 and the size of the layer of slurry 4 to be cured. As an exemplary range, the diameter may be between 1000 μm and 0.1 μm, or even between e.g. 200 μm and 4 μm for a more specific range. In the embodiment shown in FIG. 1, the method further comprises applying a radiation source 6 on the layer of slurry 4 for curing thereof before depositing a new layer of slurry 4. That is, the slurry 4 is cured and solidified by exposure of the radiation source 6, wherein the cured layer of slurry 4 is schematically shown in FIG. 1 as the striped-patterned part of the (uncured) slurry 4.

It is noted that this step of applying the radiation source 6 on the layer of slurry 4 and the curing of the layer of slurry 4 therefrom may comprise a single-step process.

The radiation source 6 may comprise any suitable type of radiation that allows the (layer of) slurry 4 to be cured, for example, visible light radiation, ultraviolet (UV) radiation or infrared (IR) radiation. In certain embodiments, the radiation source 6 may be localised on a certain part of the layer of slurry 4, and/or may comprise a high energy radiation source 6.

As a non-limiting example, radiation sources can be selected from any radiation source that operates in the required wavelength range such as light emitting diode (or array of LEDs), laser beam, or lamp, each optionally in combination with a digital light processor. As high energy radiation source also an e-beam source may be used.

Further, in this embodiment, the radiation source 6 comprises a rotating exposure, as shown in FIG. 1 by the round arrow depicting the direction of rotation of the radiation source 6. Alternatively stated, the radiation source 6 is rotating whilst being applied to the layer of slurry 4 for curing thereof.

In addition, the rotating exposure may also move around on the layer of slurry 4 (as shown by the arrows left and right of the substrate 2 in FIG. 1), to provide ex-centre (i.e. lateral) movement of the rotating exposure on the layer of slurry 4 and profile (i.e. draw) the form of the layer of slurry 4 being cured. Additionally or alternatively, also the radiation source 6 can move laterally (parallel to the plane of the substrate 2) in the indicated directions.

The rotating exposure of the radiation source 6 provides a cured layer of slurry 4 with a high accurate form and high symmetry. Since the cured layers of slurry 4 represent at least in part the abrasive article 1, the eventual abrasive article 1 is also manufactured with a high accurate form and high symmetry, and is of excellent quality. In more general wording, the present invention embodiments, as described herein, relate to a method of additive manufacturing for manufacturing an abrasive article 1 layer-by-layer, comprising depositing a layer of slurry 4, wherein the slurry 4 comprises a mixture comprising a liquid and abrasive particles, and applying a radiation source 6 on the layer of slurry 4 for curing thereof before depositing a new layer of slurry 4, wherein the radiation source 6 comprises a rotating exposure. This may provide an improved method for manufacturing an abrasive article 1 with a high accurate form and high symmetry, using the slurry 4 as the starting material (instead of e.g. powder). This may provide an abrasive article 1 of excellent quality, which is manufactured with a reliable additive manufacturing (printing) process in a proper layer-by-layer fashion, thereby easing production, and reducing the production time and associated costs.

To detail the advantageous characteristics of the method in relation to the present invention embodiments described herein, the following non-limiting example is provided. A layer of slurry 4 is deposited on e.g. a platform or substrate 2. As an exemplary example, a suitable thickness of the layer of slurry 4 adjusted to the abrasive particle size, may be less than 300 μm e.g. 5 μm (with 1 μm diameter abrasive particles). The layer of slurry 4 may be the first layer of the eventual abrasive article 1, or a subsequent layer (i.e. layers of the abrasive article 1 have already been printed). A radiation source 6 comprising a rotating exposure is applied on the layer of slurry 4 to cure and solidify the layer of slurry 4 with a high accurate form and high symmetry, whereby a layer of the abrasive article 1 is printed. A new layer of slurry 4 is then deposited on the platform or substrate 2.

The cycle of steps, as described in the above non-limiting example, are then repeated to print and build the abrasive article 1 up in a proper layer-by-layer fashion, wherein each cured layer of slurry 4 is of a high accurate form and high symmetry.

It is noted that applying the radiation source 6 may also be controlled in time, e.g. using an on-off modulation, in order to provide specific patterns of cured material of the abrasive article 1. As an example, the abrasive article 1 as provided by the present invention embodiments may comprise a grinding wheel with radially spaced grinding surfaces, separated by radially extending grooves.

In an embodiment shown in FIG. 1, the method further comprises transporting the layer of slurry 4 deposited on a substrate 2 by moving the substrate 2. To elaborate, the layer of slurry 4 is deposited on the substrate 2 and transported, through motion of the substrate 2 itself (direction depicted by arrows on the substrate 2 in FIG. 1), to a position for curing by the radiation source 6. The left-over, uncured slurry 4 is then transported away by the substrate 2, where, in tandem, a fresh layer of slurry 4 is deposited on the substrate 2 and transported towards a position for curing by the radiation source 6.

That is, a conveyor-belt like arrangement is described for depositing and transporting layers of slurry 4 in the present invention embodiments, providing efficient and productive manufacturing of the abrasive article 1. The substrate 2 may comprise a transparent substrate 2 and/or a foil substrate 2.

In a further embodiment, the method further comprises pulling the cured layer of slurry 4 away for depositing the new layer of slurry 4. To describe in further detail, once solidified, the cured layer of slurry 4 pulled away from e.g. the platform or substrate 2 by e.g. a stage. This leaves a gap between the recently cured layer of slurry 4 and the substrate 2, which can be filled with a fresh, new layer of slurry 4 for curing thereof to build and print the abrasive article 1 in an efficient layer-by-layer manner.

Further information on other embodiments for transporting of the slurry 4, and the pulling of the cured layer of slurry 4, may be found in international publication WO 2015/107066.

In an embodiment, the rotating exposure comprises a rotating beam. By virtue of using a rotating beam, the shape of the abrasive article 1 may be drawn and profiled in an even more accurate form. For example, for a circular form, a rotating beam will naturally profile the roundness of the circle in proper fashion, wherein the circumference and diameter may be determined by the size of the rotating beam e.g. the length of the rotating beam.

To that end, FIGS. 2A-C show a top view of the rotating beam for curing the (layer of) slurry 4, according to three exemplary embodiments of the method of the present invention.

In the embodiment shown in FIG. 2A, the rotating beam comprises a rotating spot 61. The rotating spot 61 comprises a focus point 61a (located at the centre of the rotating spot 61), whereby the rotating spot 61 may be applied on the layer of slurry 4 and rotate around the focus point 61a.

The rotating spot 61 may be held stationary in position, and the size of the rotating spot 61 may be varied to profile e.g. a circular form of the abrasive article 1; an increasingly larger (circular) rotating spot 61 rotating around its focus point 61a will naturally profile the roundness of an increasingly larger circle. In particular, the varying size of the rotating spot 61 may be suitable for printing small circular forms (e.g. small wheels) on different positions on the layer of slurry 4.

Alternatively, in the embodiment shown in FIG. 2B, the rotating spot 61 may be moved around on the layer of slurry 4 to form the shape of the abrasive article 1, i.e. the form is drawn out by the rotating spot 61. For example, the rotating spot 61 may move around a middle point of the layer of slurry 4 (shown as the ‘cross-hair’ in FIG. 2B) in a circular motion to profile a circular form.

To that end, it is noted that the single rotating spot 61 (described and shown in FIGS. 2A-B) is an exemplary implementation, and the rotating beam may comprise two or more rotating spots 61. For example, two rotating spots 61 may profile the inner and outer diameters of an abrasive article 1 having a circular form for manufacturing the internal and external diameters of e.g. a wheel.

In a further exemplary embodiment, the rotating spot 61 may be applied on the layer of slurry 4 and additionally rotate around the focus point 61a.

In the embodiment shown in FIG. 2C, the rotating beam comprises a rotating line 62 rotating around an end point 62a of the rotating line 62. In this manner, to profile e.g. a circular form, the rotating line 62, in this embodiment, may represent the ‘radius’ of the circle, such that rotating the rotating line 62 around its end point 62a may naturally draw out the roundness of the circle.

Alternatively, in the embodiment shown in FIG. 2D, the rotating beam comprises a rotating line 62 rotating around a centre point 62b of the rotating line 62. Again, to profile e.g. a circular form, the rotating line 62, in this FIG. 2c embodiment, may represent the ‘diameter’ of the circle to naturally draw out the roundness thereof when rotating the rotating line 62 around its centre point 62b.

In certain embodiments, as shown in FIGS. 2C-D, the rotating line 62 may comprise a partial rotating line 62c rotating around the respective end point 62a and centre point 62b. The partial rotating line 62c represents a part of the full rotating line 62 that is rotating (as marked between the dotted lines on the full rotating line 62 in FIGS. 2C-D), and the rest of the full rotating line 62 may be held stationary in position, or even be absent. This may be advantageous for e.g. providing a hollow part or hole in a part of the abrasive article 1, for which, during the printing process, parts of the layer of slurry 4 are left uncured.

It is noted that the embodiments described for the rotating beam (as shown in FIGS. 2A-D) are exemplary embodiments, and alternative implementations of the rotating beam are possible. For example, different forms (square, oval, triangle etc.) may be profiled, and it is envisaged that the size, length and thickness etc. of the rotating spot 61 or rotating beam 62 may also vary in-situ whilst being applied on the (layer of) slurry 4 for curing thereof. Furthermore, the end point 62a and centre point 62b, in the FIGS. 2B and 2C embodiments, respectively, may located at different positions of the rotating line 62.

In a further exemplary embodiment, the radiation source 6 comprises a laser for curing the layer of slurry 4 using a melting or sintering process. That is, a selective laser melting or selective laser sintering process may be used, wherein the abrasive particles in the layer of slurry 4 are (fully) melted or sintered together during the curing process, subsequently forming a cured layer of slurry 4.

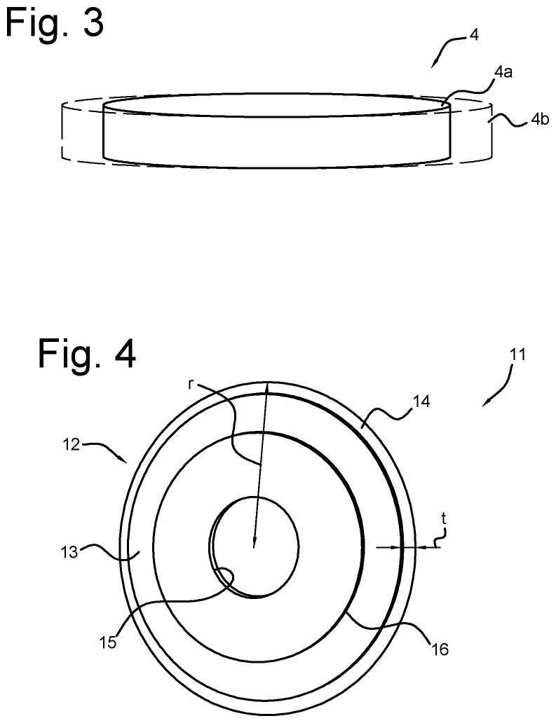

FIG. 3 shows a schematic view of the layers of slurry 4, according to an advantageous embodiment of the present invention. In this advantageous embodiment, a cross-sectional area 4a of the previous cured layer of slurry 4 is different than a cross-sectional area 4b of the subsequent cured layer of slurry 4. Alternatively stated, not only is the eventual abrasive article 1 built up and printed in a layer-by-layer fashion, but by varying the size of the rotating exposure, increasingly larger or smaller cross-sectional areas 4a, 4b of the layers of slurry 4 are exposed to and cured by the rotating exposure. Layers of the abrasive article 1 are then printed with increasingly larger cross sections 4a, 4b until the desired cross-sectional area of the final form has been obtained. Furthermore, it is possible to have subsequent layers which are smaller or larger than a previous layer, allowing to obtain an abrasive article 1 with a radius profile, concave profile, or any other free form shape.

In this manner, the abrasive article 1 may be printed and built up in an even more efficient layer-by-layer fashion, whereby the cross-sectional area thereof may be adjusted for each (deposited) layer of slurry 4 with high accuracy.

Accordingly, in an even further embodiment shown in FIG. 3, the cross-sectional area 4a, 4b comprises a circular cross-sectional area. With reference to FIG. 3, for an abrasive article 1 comprising a (substantially) circular form, by changing e.g. the radius of the rotating exposure, the cross-sectional area 4b of the subsequent layer of slurry 4 is different than the cross-sectional area 4a of the preceding (cured) layer of slurry 4. This may implemented for each deposited layer of slurry 4, and the abrasive article 1 is built-up with different radius.

In an exemplary embodiment, a resolution of the cured layer of slurry 4 is less than 5 μm e.g. 1 μm. As already described herein, the accuracy of the final form should be in the order of μm; in state-of-the-art methods, the accuracy is limited by the pixel size of the illumination or energy source directed onto the layer of abrasive article, and is in the order of tens of microns e.g. 50 μm. By applying a rotating exposure on the layer of slurry 4, the form is drawn out by the rotation of the exposure, and the accuracy is no longer limited by the pixel size, providing cured layers of slurry 4 of very high resolution with e.g. micron precision.

It is noteworthy to mention that the although the layer of slurry 4 may comprise a mixture comprising larger sized abrasive particles having e.g. 100 μm diameter, in this embodiment, the resolution is still less than 5 μm e.g. 1 μm by application of the rotating exposure on the cured layer of slurry 4 and the form is still of high precision and accuracy, but, naturally, the cured layer of slurry 4 may be subject more ‘surface roughness’ owing to the larger sized abrasive particles.

In a further exemplary embodiment, the abrasive particles comprises one or more of the following: diamond particles, cubic boron nitride particles, borazon particles, metal particles, ceramic particles, glass particles, powder particles and/or precursor, or sintering aid particles, allowing the use of a diversity of materials for manufacturing an abrasive article 1 layer-by-layer. It is noted that the abrasive particles, as described in this embodiment, have proper abrasive properties, and any composition or combination of particles may be used as abrasive particles in the slurry 4, e.g. a composition of diamond and metal particles. As exemplary examples, the metal particles may comprise brass/or steel bonding particles.

In an even further exemplary embodiment, the slurry 4 comprises different compositions for new layers of the slurry 4. That is, different slurry compositions are used for a new layer of the abrasive article 1, thereby resulting in an abrasive article 1 comprising layers of different compositions. This is advantageous for providing graded structures or grinding grains on different layers in the abrasive article 1, and, in particular, for manufacturing combined pre-grinding and polishing tools.

In yet a further embodiment, the slurry 4 further comprises bonding agents, optional fillers and/or additives. The bonding agents may improve the cohesion between the abrasive particles in the slurry 4 to enhance the alignment of the abrasive particles before and/or during curing of the slurry 4. The optional fillers and additives may improve specific properties of the slurry 4 to enhance the curing thereof, thereby providing a final abrasive article 1 of even better quality. The bonding agent, optional fillers and/or additives (e.g. sintering aids) may comprise any suitable material known to the skilled person may be used, assuming the steps of the method embodiments described herein may be carried out when these material are included. As exemplary examples, the optional fillers may comprise calcium carbonate, glass, korrund and/or silicon carbide. As a further exemplary embodiment, a sintering step may be added after the printing process, providing a vitrified or metal bond material in the end product. According to a further aspect, the present invention also relates to a method of additive manufacturing for manufacturing an abrasive work tool 11 comprising the abrasive article 1 according to any one of embodiments described herein. The abrasive work tool 11 is arranged for use in any abrasive machining process using an abrasive article 1, including fixed abrasive processes (grinding, honing, sanding etc.) and loose abrasive processes (polishing, lapping etc.). Further, the abrasive work tool 11 may comprise any suitable work tool for an abrasive machining process; exemplary examples including sanding paper, polishing discs, grinding needles and grinding pads.

FIG. 4 shows an schematic view of the abrasive tool 11 according to an embodiment of the present invention. In the embodiment (shown in FIG. 4), the abrasive tool 11 comprises a grinding wheel 12 comprising a body 13 and an abrasive rim 14 comprising the abrasive article 1. The circular shape of the grinding wheel 12 may be manufactured with an accurate form, and both the body 13 and abrasive rim 14 may be manufactured and printed in a proper layer-by-layer fashion by any one of the method embodiments described herein.

The abrasive rim 14 comprising the abrasive article 1 may comprise any suitable abrasive particles for grinding, i.e. it is the abrasive part of the abrasive tool 11 for active grinding. Further, as shown in FIG. 3, the abrasive rim 14 is provided on the periphery of the body 13.

The grinding wheel 12 comprising the abrasive rim 14 may be suitable for peripheral grinding processes, wherein the periphery of the grinding wheel (i.e. the abrasive rim 14) is in contact with the work piece, to produce e.g. a flat surface.

With this in mind, in a specific embodiment shown in FIG. 4, the abrasive rim 14 has a thickness tof at least one layer of the abrasive article 1. For example, if the thickness of one layer of the abrasive article 1 is 5 μm, then the abrasive rim 14 has a thickness tof 5 μm. As an exemplary range, the thickness t may be between 3-10 mm. In certain embodiments, the grinding wheel 12 has a radius r of at least 1 mm e.g. 250 mm, as shown in FIG. 4. Using the method embodiments described herein, it is possible to manufacture grinding wheels 12 having a radius r of more than 1000 mm.

In a further specific embodiment relating to the abrasive tool 11, the method further comprises forming a bore 15 in the abrasive tool 11 (as shown in FIG. 4). As known to the skilled person, the bore 15 may allow the abrasive tool 11 to be fitted onto e.g. the spindle of a grinding machine. By forming the bore 15 during the additive manufacturing process, this may even further simplify the manufacturing of such an abrasive tool 11 without, for example, having a separate, external step to form the bore 15 after the abrasive tool 11 has already been printed and manufactured.

In other embodiments relating to the abrasive tool 11, the method further comprises forming a support ring element 16 on the abrasive tool 11 for alignment with e.g. the grinding ring shaft on a grinding machine.

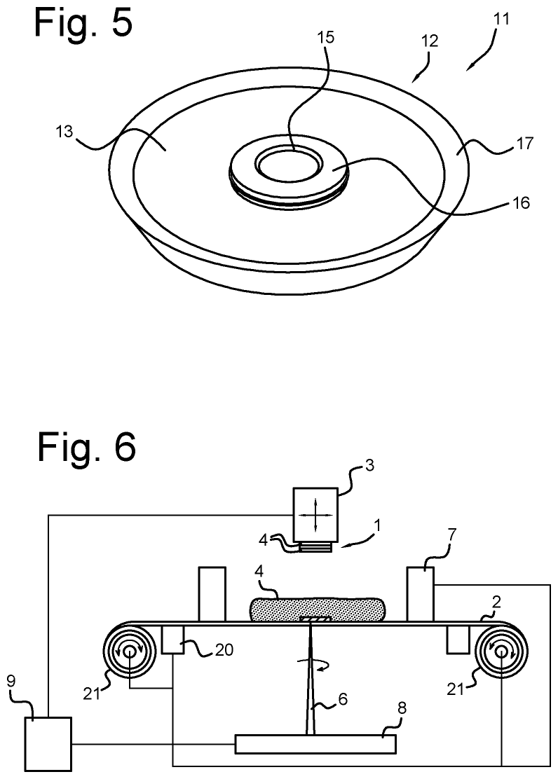

It is re-iterated that the embodiments relating the grinding wheel 12 comprising an abrasive rim 14 is an exemplary embodiment, and other possible implementations of the (active) abrasive part on the grinding wheel 12 may be envisaged. For example, in yet another exemplary embodiment shown in FIG. 5, the grinding wheel 12 may comprise a abrasive face rim 17 comprising the abrasive article 1. The abrasive face rim 17 may be provided on a surface of the grinding wheel 12, e.g. an external surface. Such an abrasive face rim 17 may be suitable for face grinding processes (e.g. optical and polishing applications), wherein the face of the grinding wheel (i.e. the abrasive face rim 17) is used on and in contact with a flat or curved surface of the work piece, e.g. wherein the face of the grinding wheel is at an angle to a concave or convex (optical) surface. Similar to the embodiment described herein for FIG. 4, the abrasive face rim 17 may also have a thickness t of one layer of abrasive article 1 e.g. 5 μm, and a radius of at least 1 mm (and even more than 1000 m).

Other possible implementations include the grinding wheel 12 comprising a general abrasive face, i.e. an entire face of the grinding wheel 12 comprises the abrasive article 1, or even a grinding wheel 12 comprising entirely of the abrasive article 1, i.e. both the body 13 and abrasive rim 14 (or abrasive face rim 17) comprise the abrasive article 1.

Furthermore, for the method embodiments described herein, the abrasive article 1 may comprise a porosity and coolant structure, which may be manufactured by, for example, depositing a layer of slurry 4 comprising larger-sized abrasive particles.

In addition, for the method embodiments described herein, a further step may be implemented to remove the uncured part of the slurry 4 for depositing a fresh, new layer of slurry 4. The uncured slurry 4 may be removed by being e.g. transport away or scraped away by a scraper, and the uncured slurry 4 may be re-used, leading to less waste slurry 4 and better re-use thereof for efficient additive manufacturing.

Additional steps (for the method embodiments described herein) may be implemented to apply additional (heat) treatments after the abrasive article 1 has been printed. The type of additional (heat) treatment will depend on the final bond type; as an example, resin bond potential thermal hardening of metal and ceramic/vitrified bond de-binding and sintering may be applied to get to the final bond system. Even further method steps may be implemented to provide a masking screen disposed substantially parallel to the layer of slurry 4, and between the radiation source 6 and layer of slurry 4, for blocking at least in part the radiation source 6 on the layer of slurry 4. The masking screen may comprise slits in the order of e.g. μm to also provide a cured layer of slurry 4 of high resolution and accuracy.

The above described method embodiments may be implemented using an additive manufacturing apparatus for manufacturing an abrasive article 1 layer-by-layer. As shown in the schematic view of an embodiment of the present invention apparatus in FIG. 6, the apparatus comprises a substrate 2, a slurry depositor 7 arranged to deposit a layer of slurry 4 on the substrate 2, wherein the slurry 4 comprises a mixture comprising a liquid and abrasive particles, and a radiation unit 8 arranged to apply a radiation source 6 on the layer of slurry 4 for curing thereof before depositing a new layer of slurry 4, wherein the radiation source 6 comprises a rotating exposure.

As in the method embodiments described above, the substrate 2 may comprise a transparent and/or foil substrate 2, and the slurry 4 may be implemented as a paste, resin, dispersion, suspension etc., wherein the mixture comprising the liquid and abrasive parties eventually forms the (printed) abrasive article 1. The (part of the) layer of slurry 4 cured by the radiation source 6 is depicted in FIG. 6 as the striped-patterned part (of the uncured slurry 4).

In a further embodiment (shown in FIG. 6), the radiation unit 8 comprises a laser device, wherein the laser device may comprise any suitable laser for curing the layer of slurry 4. As exemplary examples, the laser device may comprise a solid state or semiconductor laser having a pulsed or continuous wave laser output, or even a computer numerically controlled (CNC) laser to apply the radiation source 6 in (patterned) doses.

In yet a further embodiment shown in FIG. 6, the apparatus of the present invention further comprises a stage 3 configured to hold the one or more cured layers of slurry 4 representing at least in part the abrasive article 1. As shown in FIG. 1, the stage 3 is movably disposed relative to the substrate 2, and may control the X-Y-Z position(s) of the one or more cured layers of slurry 4, wherein the Z-position is the height position of the stage 3 perpendicular to the substrate 2 (i.e. the stage 3 is raised from and lowered towards the substrate 2), and the X-Y positions are parallel to the substrate 2.

By controlling the Z-position, the stage 3 may bring the one or more cured layers of slurry 4 into and out of contact with the (fresh) layer of slurry 4 on the substrate 2 before and after, respectively, the radiation source 6 is applied. This cycle can be repeated to build the abrasive article 1 up in a proper layer-by-layer fashion. By controlling the X-Y positions of the stage 3, the one or more cured layers of slurry 4 on the stage 3 may accurately be positioned parallel to the substrate 2 before (or even during/after) contact with the fresh, deposited layer of slurry 4.

In an exemplary embodiment shown in FIG. 6, the apparatus of the present invention further comprises a substrate handling system 20, 21 for supplying, moving and receiving the substrate 2.

The substrate handling system 20, 21 comprises a substrate control unit 20 and substrate rollers 21. The substrate rollers 21 comprise a substrate supply roll and a substrate receive roll rotatably arranged for moving the substrate 2, as shown by the direction arrows on the substrate rollers 21 in FIG. 6. The substrate control unit 20 may control the rotation of the substrate rollers 21, including parameters thereof, e.g. speed and start/stop commands.

As described herein, the layer of slurry 4 is deposited on the substrate 2 for curing thereof. Thus, by having a substrate handling system 20, 21, efficient transport of the slurry 4 (and possible removal thereof) is provided. Further information on other embodiments regarding the substrate handling system 20, 21 may be found in international publication WO 2015/107066.

In yet a further exemplary embodiment for the apparatus of the present invention shown in FIG. 6, the apparatus further comprises a control unit 9 connected to the slurry depositor 7 and radiation unit 8, wherein the control unit 9 is arranged to execute the steps of any of the present invention method embodiments described herein. This may allow the process of additive manufacturing of the abrasive article 1 to be automatically controlled. As exemplary examples, the control unit 9 may control the slurry depositor 7 to deposit a pre-determined (layer) amount of slurry 4 on the substrate 2, and/or control the radiation unit 8 to apply the radiation source 6 on the layer of slurry 4 for a pre-determined time (i.e. specific length of exposure time). In the embodiment shown, the radiation source 6 is depicted off centre to indicate that the spot on the abrasive article 1 is provided as a moving circle pattern to ‘write’ parts of the abrasive article with a well-defined radius.

As other possible examples, if the embodiment of the control unit 9 can be combined with the embodiments described herein relating to the stage 3, the X-Y-Z position of the one or more cured layers of slurry 4 can be controlled. For example, the control unit 9 may be connected to the stage 3 (see FIG. 1), and may control the Z-position of the stage 3 to be lowered into contact with a fresh deposited layer of slurry 4, and raised from the layer of slurry 4 after curing.

Similarly, in yet another possible example, if the control unit 9 embodiment can be combined with the substrate handling system 20, 21 embodiment described herein, the supply of the substrate 2 may be controlled for transporting the layer of slurry 4 deposited on the substrate 2. For example, the control unit 9 may be connected to the substrate control unit 20, as shown in FIG. 1, and control the transportation of layer of slurry 4 on the substrate 2.

In an even further embodiment, the apparatus may be provided with a slurry handling assembly, e.g. in the form of wipers interacting with the surface of the substrate 2. The slurry handling assembly is arranged to (re-)collect unused slurry from each deposited layer, and e.g. also for reconditioning the slurry material. Especially when the slurry composition comprises expensive materials (e.g. diamond or other super-abrasive powders), re-use of the slurry material with the slurry handling assembly is providing high cost benefits.

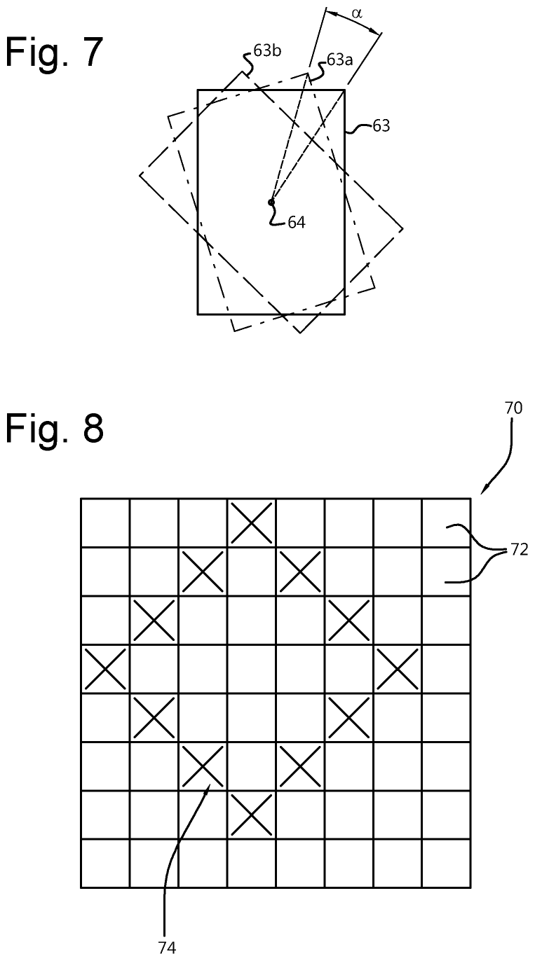

FIG. 7 shows a schematic top view of a stack of cured layers created by a method for manufacturing an abrasive article layer-by-layer, according to an embodiment of the present invention.

In this embodiment, the radiation source 6 is configured to generate a beam that has a substantially non-circular cross-section at least at the level of the layer of slurry 4 that is to be exposed to the radiation.

As an example a rectangular spot of the beam is used to create cured layers but the spot may have a different shape as well: for example outlined as square, elliptical, rhombic, triangular or similar.

The method comprises that a layer of slurry 4 is exposed to radiation from the spot while the spot is in a fixed but predetermined orientation. In this manner, a first cured layer 63 of the abrasive article 1 to be formed is printed with substantially same shape as the radiating spot. In a next step the process is repeated by providing a next layer of slurry over the first cured layer 63 of the abrasive article and exposing the layer of slurry to the radiation in the spot 63. According to this embodiment, in this next step the spot has been rotated over a predetermined angle α around a center 64 of the spot. As a result a next cured layer 63a of the abrasive article has a same shape as the first cured layer of the abrasive article but is rotated over the predetermined angle α.

By repeating from one layer to a next layer for a plurality of cured layers, a stack of mutually rotated cured layers of the abrasive article is formed in which the overlap between the layers has a circular shape, or approaches a circular shape depending on the size of the predetermined angle and the number of layers in the abrasive article. FIG. 7 shows the structure of the stack of layers (or spot positions) schematically for a first layer 63 (solid line), a second layer 63a (dot-dashed line) and a third layer 63b (dashed line). It will be appreciated that to approach a circular overlap, the layer by layer exposure can be repeated for an arbitrary number of cured layers and a suitably selected rotation angle from one layer to the next layer depending on the shape and symmetry of the spot.

FIG. 8 shows a schematic view of a source to generate a spot of an exposure beam used in a method for manufacturing an abrasive article layer-by-layer, according to an embodiment of the present invention.

According to this embodiment, the radiation source 6 comprises a light source matrix 70 with a plurality of addressable light beam sources 72, or pixels which may comprise LEDs or laser devices.

The radiation source is configured for generating a spot with any shape that can be provided by activating the light beam sources 72 according to a pattern 74 corresponding with the shape.

The pattern is created by selecting light beam sources within the matrix 70. The pattern can be any of open contour or a filled contour to define the spot. If the resolution of the matrix is sufficient (i.e. having a comparatively large number of pixels in the matrix) the pattern can be a circular dot, an annulus, an ellipse, an arc, a rectangular block or outline, etc.

As an example, FIG. 8 shows a light source matrix 70 with addressable pixels in 8×8. However, other pixel sizes of the matrix are feasible as well. In particular for larger numbers of pixels, the resolution of the generated spot and pattern will be higher. Furthermore, pixels within the light source matrix can be square, rectangular, dot-shaped or similar.

In FIG. 8 activated pixels 72 are indicated by ‘x’, in this example forming a diamond-shaped open contour as pattern 74.

By rotating the pattern on the light source matrix, a similar effect as with a rotating spot can be achieved as explained in FIGS. 2A-2D. Additionally or alternatively, a similar effect as creating a circular abrasive article as result of overlapping rotated layers in an abrasive article grown layer by layer can be achieved as explained with reference to FIG. 7.

Instead of rotating the pattern on the light source matrix, a rotation of the stage (not shown here) relative to a fixed pattern on the light source matrix can be used during the exposure to create an abrasive article.

The present invention has been described above with reference to a number of exemplary embodiments as shown in the drawings. Modifications and alternative implementations of some parts or elements are possible, and are included in the scope of protection as defined in the appended claims.

1. A method of additive manufacturing for manufacturing an abrasive article layer-by-layer, the method comprising depositing a layer of slurry, wherein the slurry comprises a mixture comprising a liquid and abrasive particles, and applying a radiation source on the layer of slurry for curing thereof before depositing a new layer of slurry, and
wherein the radiation source comprises a rotating beam with a profiled spot configured for moving the profiled spot around a middle point of the layer of slurry in a circular motion.

2. The method according to claim 1, wherein the rotating beam has a rotating profiled spot.

3. (canceled)

4. (canceled)

5. The method according to claim 1, wherein the radiation source comprises a laser for curing the layer of slurry using a melting or sintering process.

6. The method according to claim 1, wherein a cross-sectional area of the previous cured layer of slurry is different than a cross-section area of the subsequent cured new layer of slurry.

7. The method according to claim 6, wherein the cross-sectional area comprises a circular cross-sectional area.

8. The method according to claim 1, wherein a resolution of the cured layer of slurry 4 is less than 5 μm, e.g. 1 μm.

9. The method according to claim 1, wherein the abrasive particles comprises one or more of the following: diamond particles, cubic boron nitride particles, borazon particles, metal particles, ceramic particles, glass particles, powder particles and/or precursor, or sintering aid particles.

10. The method according to claim 1, wherein the slurry comprises different compositions for new layers of the slurry.

11. The method according to claim 1, wherein the slurry further comprises bonding agents, optional fillers and/or additives.

12. The method according to claim 1 further comprising transporting the layer of slurry deposited on a substrate by moving the substrate.

13. The method according to claim 1, further comprising pulling the cured layer of slurry away for depositing the new layer of slurry.

14. An additive manufacturing apparatus for manufacturing an abrasive article layer-by-layer, the apparatus comprising
a substrate,
a slurry depositor arranged to deposit a layer of slurry on the substrate,
wherein the slurry comprises a mixture comprising a liquid and abrasive particles, and
a radiation unit arranged to apply a radiation source on the layer of slurry for curing thereof before depositing a new layer of slurry,
wherein the radiation source comprises a rotating beam with a rotatable profiled spot configured to move around a middle point of the layer of slurry in a circular motion.

15. The additive manufacturing apparatus according to claim 14, wherein the rotating beam has a rotating spot.

16. (canceled)

17. (canceled)

18. The additive manufacturing apparatus according to claim 14, wherein the radiation unit comprises a laser device.
